(19) United States
(12) Patent Application Publication
(10) Pub. No.: US 2011/0191852 A1
(43) Pub. Date: Aug. 4, 2011

(54) METHOD TO PERFORM A SECURITY ASSESSMENT ON A CLONE OF A VIRTUAL SYSTEM

(75) Inventors: Scott Sanders, Boulder, CO (US); Mark King, Vacaville, CA (US)

(73) Assignee: Scott Sanders, Boulder, CO (US)

(21) Appl. No.: 12/697,240

(22) Filed: Jan. 30, 2010

(51) Int. Cl. G06F 21/00; G06F 9/455

(52) U.S. Cl. 726/25; 718/1

(57) ABSTRACT

A system to create a virtual clone of a production system for the purpose of executing security services without risk to the original production system. The service host makes a copy of the dedicated memory and physical storage of the virtual target, and then uses that data to initiate a clone in an isolated virtual environment within the service host. Once the target system has been cloned, security services can be performed on the clone without any risk to the target system, and provide an accurate reflection of the security state of the target system.

### BACKGROUND

1. Field

The present invention relates to the ability to create a virtual clone of a production virtual server for the purpose of reducing the risk of non-desirable outcomes to the original server during the process of performing security services such as vulnerability scans and more particularly, during the process of attempting to exploit found vulnerabilities on the production virtual server.

2. Related Art

In order to provide security services such as vulnerability scans and penetration tests of servers, the servers must first be scanned for known vulnerabilities. Once the full range of suspected vulnerabilities is compiled, they must be individually verified by attempts to exploit each vulnerability. If exploited, these vulnerabilities can cause harmful or non-desirable affects to the host system such as application freezes, data corruption, or other system downtime issues. These servers are actively providing services to users; therefore any non-desirable outcome or system failure can cause business interruptions and financial losses.

System downtime due to security assessments can be minimized by creating a full duplicate of the production environment and systems in a development or test area and performing initial assessments in this environment.

Another means of minimizing system downtime due to security assessments is to schedule the security assessments around the usual use periods of the systems or to schedule maintenance windows where the system will be unavailable.

Another means of minimizing system downtime due to security assessments is to alter the process to exploit suspected vulnerabilities in order to reduce risk to the target system and hosted applications.

Duplicating a full production environment can be a very expensive and technically complex undertaking. To fully duplicate a production environment would require the expenditure of capital equal to the cost of the original environment as well as additional management and administration to keep the environments in sync. Finally, certain business regulations require security assessments to be performed on the production equipment itself regardless of the existence of a duplicate test environment.

Certain business regulations require penetration tests to be executed against the production systems for compliance.

Scheduling security assessments around use periods of the system or within prescribed maintenance windows can be a complicated process, depending on the number of users of the system and other inter-related components. It

[symbol]

### SUMMARY

In accordance with the present invention, there is provided a system to create a virtual clone of a production system for the purpose of executing security services without risk to the original production system.

The target system (target guest) is virtualized, running on top of a physical host (target host) configured with a virtualization platform such as VMWare, KVM, or Xen.

The service provider system is a physical host (service host) configured with a standard virtualization platform identical to or compatible with the virtualization platform on the target host, such as VMWare, KVM or Xen.

When initiated, the service host will open a communication session with the target host and request a shadow copy of the target guest memory and physical storage data. The service host will use this data to create a virtual clone of the production system within an isolated virtualization environment. Once the clone is initialized and running, the service host will perform the security services on the clone or allow an external system to access the isolated virtual environment containing the clone to provide the security services. After all security applications have completed, the clone can be shut off and all data files deleted.

It would be advantageous to provide a simple means to clone a virtual system for the purpose of providing security services.

It would also be advantageous to provide a simple means of providing security services to a virtual system.

It would also be advantageous to provide a means of preventing duplicate resource conflicts between the original virtual systems and a clone of the virtual system.

It would also be advantageous to provide means to provide security services to virtual systems without requiring resource scheduling.

It would further be advantageous to provide an automated means of providing security services to virtual systems without increasing the risk of service interruption.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a FIG. 1 shows a schematic diagram of the components need to create a virtual clone for the purposes of performed security services.

For purposes of clarity and brevity, like elements and components will bear the same designations and numbering throughout the FIGURES.

### DETAILED DESCRIPTION

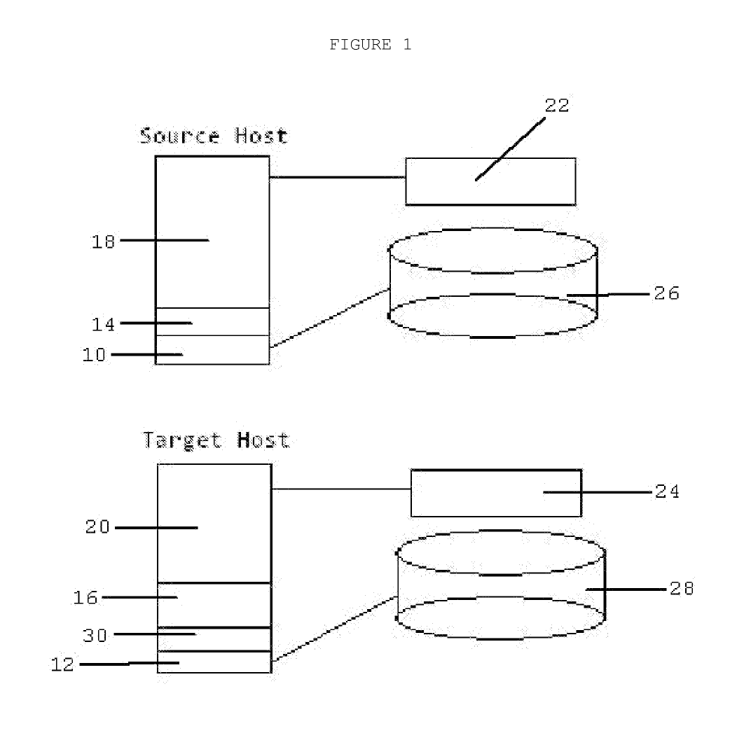

FIG. 1 is a detail view of a schematic diagram of the components needs to create a virtual clone for the purposes of performing security services.

The source guest 18 is virtual, running on top of a source host virtualization layer 14. The service host is configured with a service host virtualization layer 16 and available capacity to hold the clone guest 20.

The service host operating system 12 opens a communication session with the source host operating system 10 and requests a shadow copy of the isolated source guest memory 22 on the source host. Once the copy of the isolated source guest memory 22 to the service host is complete, the service host operating system 12 will freeze the copy of the isolated source guest memory 22 and designate it as the isolated clone guest memory 24 in the service host virtualization layer 16. The service host operating system 12 then initiates a shadow copy of the source guest 18 data files from the source host physical storage 26. The copy of the service host physical storage 28 is saved to the service host physical storage 28 and assigned to the clone guest 20 virtual image within the service host virtualization layer 16. The service host virtualization layer 16 initiates a connection to the source host virtualization layer 14 on the source host and identifies the operating parameters of the source guest 18 and then duplicates them within the service host virtualization layer 16 for the clone guest 20 image. The isolated clone guest memory 24 is linked to the clone guest 20 image and unfrozen so that the clone guest 20 is active within the isolated service host virtualization layer 16. The security application 30 can then be executed by the service host upon the isolated clone guest 20 directly or through a network bridge created between the service host virtualization layer 16 and a physical or virtual network that is connected to the system(s) providing the security services. The clone guest 20 can be reset to a pre-application status between applications of the security services in the event of detrimental outcomes by reverting to the original state of the isolated clone guest memory 24. Once the security services are completed the clone guest 20 can be powered off and the isolated clone guest memory 24 and data store in the service host physical storage 28 can be erased.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. A method to perform a security assessment on a clone of a virtual system for reducing the risk of non-desirable outcomes on the original server during a security assessment, comprising:
Means for providing core system functionality and hosting the virtualization layer and any application layers;
Means for providing core system functionality and hosting the virtualization layer and any application layers;
Means for providing an interface between the virtualized guests and components and the underlying operating system and hardware of the host, specifically connected to said means for providing core system functionality and hosting the virtualization layer and any application layers;
Means for providing an interface between the virtualized guests and components and the underlying operating system and hardware of the host, specifically connected to said means for providing core system functionality and hosting the virtualization layer and any application layers;
Means for providing services, completely housed to said means for providing an interface between the virtualized guests and components and the underlying operating system and hardware of the host;
Means for providing a target for the security assessment, completely housed to said means for providing an interface between the virtualized guests and components and the underlying operating system and hardware of the host;
means for running the source guest virtual image, respectively connected to said means for providing an interface between the virtualized guests and components and the underlying operating system and hardware of the host;
means for running the clone guest virtual image, respectively connected to said means for providing an interface between the virtualized guests and components and the underlying operating system and hardware of the host;
means for containing the physical data for the source host operating system and virtual guests, rigidly connected to said means for providing core system functionality and hosting the virtualization layer and any application layers;
means for containing the physical data for the service host operating system and virtual guests, rigidly connected to said means for providing core system functionality and hosting the virtualization layer and any application layers; and
means for providing security services such as vulnerability assessments and penetration tests, normally joined to said means for providing core system functionality and hosting the virtualization layer and any application layers.

2. The method to perform a security assessment on a clone of a virtual system in accordance with claim 1, wherein said means for providing core system functionality and hosting the virtualization layer and any application layers comprises a source host operating system.

3. The method to perform a security assessment on a clone of a virtual system in accordance with claim 1, wherein said means for providing core system functionality and hosting the virtualization layer and any application layers comprises a service host operating system.

4. The method to perform a security assessment on a clone of a virtual system in accordance with claim 1, wherein said means for providing an interface between the virtualized guests and components and the underlying operating system and hardware of the host comprises a source host virtualization layer.

5. The method to perform a security assessment on a clone of a virtual system in accordance with claim 1, wherein said means for providing an interface between the virtualized guests and components and the underlying operating system and hardware of the host comprises a service host virtualization layer.

6. The method to perform a security assessment on a clone of a virtual system in accordance with claim 1, wherein said means for providing services comprises a virtual source guest.

7. The method to perform a security assessment on a clone of a virtual system in accordance with claim 1, wherein said means for providing a target for the security assessment comprises a virtual, isolated clone guest.

8. The method to perform a security assessment on a clone of a virtual system in accordance with claim 1, wherein said means for running the source guest virtual image comprises an isolated source guest memory.

9. The method to perform a security assessment on a clone of a virtual system in accordance with claim 1, wherein said means for running the clone guest virtual image comprises an isolated clone guest memory.

10. The method to perform a security assessment on a clone of a virtual system in accordance with claim 1, wherein said means for containing the physical data for the source host operating system and virtual guests comprises a source host physical storage.

11. The method to perform a security assessment on a clone of a virtual system in accordance with claim 1, wherein said means for containing the physical data for the service host operating system and virtual guests comprises a service host physical storage.

12. The method to perform a security assessment on a clone of a virtual system in accordance with claim 1, wherein said means for providing security services such as vulnerability assessments and penetration tests comprises a security application.

13. A method to perform a security assessment on a clone of a virtual system for reducing the risk of non-desirable outcomes on the original server during a security assessment, comprising:
a source host operating system, for providing core system functionality and hosting the virtualization layer and any application layers;
a service host operating system, for providing core system functionality and hosting the virtualization layer and any application layers;
a source host virtualization layer, for providing an interface between the virtualized guests and components and the underlying operating system and hardware of the host, specifically connected to said source host operating system;
a service host virtualization layer, for providing an interface between the virtualized guests and components and the underlying operating system and hardware of the host, specifically connected to said service host operating system;
a virtual source guest, for providing services, completely housed to said source host virtualization layer;
a virtual, isolated clone guest, for providing a target for the security assessment, completely housed to said service host virtualization layer;
an isolated source guest memory, for running the source guest virtual image, respectively connected to said source host virtualization layer;
an isolated clone guest memory, for running the clone guest virtual image, respectively connected to said service host virtualization layer;
a source host physical storage, for containing the physical data for the source host operating system and virtual guests, rigidly connected to said source host operating system;
a service host physical storage, for containing the physical data for the service host operating system and virtual guests, rigidly connected to said service host operating system; and
a security application, for providing security services such as vulnerability assessments and penetration tests, normally joined to said service host operating system.

14. A method to perform a security assessment on a clone of a virtual system for reducing the risk of non-desirable outcomes on the original server during a security assessment, comprising:
a source host operating system, for providing core system functionality and hosting the virtualization layer and any application layers;
a service host operating system, for providing core system functionality and hosting the virtualization layer and any application layers;
a source host virtualization layer, for providing an interface between the virtualized guests and components and the underlying operating system and hardware of the host, specifically connected to said source host operating system;
a service host virtualization layer, for providing an interface between the virtualized guests and components and the underlying operating system and hardware of the host, specifically connected to said service host operating system;
a virtual source guest, for providing services, completely housed to said source host virtualization layer;
a virtual, isolated clone guest, for providing a target for the security assessment, completely housed to said service host virtualization layer;
an isolated source guest memory, for running the source guest virtual image, respectively connected to said source host virtualization layer;
an isolated clone guest memory, for running the clone guest virtual image, respectively connected to said service host virtualization layer;
a source host physical storage, for containing the physical data for the source host operating system and virtual guests, rigidly connected to said source host operating system;
a service host physical storage, for containing the physical data for the service host operating system and virtual guests, rigidly connected to said service host operating system; and
a security application, for providing security services such as vulnerability assessments and penetration tests, normally joined to said service host operating system.
